(19) United States
(12) Patent Application Publication
(10) Pub. No.: US 2014/0204851 A1
(43) Pub. Date: Jul. 24, 2014

(54) ENHANCED PHYSICAL BROADCAST CHANNEL FOR NEW CARRIER TYPE IN LONG TERM EVOLUTION

(71) Applicant: QUALCOMM Incorporated, San Diego, CA (US)

(72) Inventors: Wanshi CHEN, San Diego, CA (US); Aleksandar DAMNJANOVIC, Del Mar, CA (US); Peter GAAL, San Diego, CA (US); Durga Prasad MALLADI, San Diego, CA (US); Tao LUO, San Diego, CA (US); Hao XU, San Diego, CA (US); Yongbin WEI, San Diego, CA (US)

(73) Assignee: QUALCOMM INCORPORATED, San Diego, CA (US)

(21) Appl. No.: 14/108,722

(22) Filed: Dec. 17, 2013

Related U.S. Application Data
(60) Provisional application No. 61/754,463, filed on Jan. 18, 2013.

(51) Int. Cl. H04W 72/04; H04L 5/00

(52) U.S. Cl. CPC H04W 72/0486; H04L 5/0048
USPC 370/329

(57) ABSTRACT

Aspects of the present disclosure provide techniques and apparatus for enhanced physical broadcast channel (PBCH) for new carrier type (NCT) in long term evolution (LTE). According to certain aspects, a method for wireless communications by a base station (BS) is provided. The method generally includes generating an enhanced physical broadcast channel (EPBCH) using a frequency division multiplexed (FDM) structure, wherein the EPBCH spans substantially a subframe duration and transmitting the EPBCH.

### CLAIM OF PRIORITY UNDER 35 U.S.C. §119

This application claims benefit of U.S. Provisional Patent Application Ser. No. 61/754,463, filed Jan. 18, 2013, which is herein incorporated by reference in its entirety.

### BACKGROUND

I. Field

Certain aspects of the present disclosure generally relate to wireless communications and, more specifically, to enhanced physical broadcast channel (PBCH) for new carrier type (NCT) in long term evolution (LTE).

II. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3rd Generation Partnership Project (3GPP) Long Term Evolution (LTE) including LTE-Advanced systems and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input single-output, multiple-input single-output or a multiple-input multiple-output (MIMO) system.

### SUMMARY

Certain aspects of the present disclosure provide a method for wireless communications by a base station (BS). The method generally includes generating an enhanced physical broadcast channel (EPBCH) using a frequency division multiplexed (FDM) structure, wherein the EPBCH spans substantially a subframe duration; and transmitting the EPBCH.

Certain aspects of the present disclosure provide a method for wireless communications by a base station (BS). The method generally includes determining a set of resources for an enhanced physical broadcast channel (EPBCH), wherein the set of resources is the same as those for a legacy physical broadcast channel (PBCH); generating at least a portion of the EPBCH in a manner that allows the EPBCH to be distinguished from a legacy PBCH; and transmitting the EPBCH to at least one user equipment (UE) based on the determined set of resources for the EPBCH.

Certain aspects of the present disclosure provide an apparatus for wireless communications by a base station (BS). The apparatus generally includes means for generating an enhanced physical broadcast channel (EPBCH) using a frequency division multiplexed (FDM) structure, wherein the EPBCH spans substantially a subframe duration; and means for transmitting the EPBCH.

Certain aspects of the present disclosure provide an apparatus for wireless communications by a base station (BS). The apparatus generally includes means for determining a set of resources for an enhanced physical broadcast channel (EPBCH), wherein the set of resources is the same as those for a legacy physical broadcast channel (PBCH); means for generating at least a portion of the EPBCH in a manner that allows the EPBCH to be distinguished from a legacy PBCH; and means for transmitting EPBCH to at least one user equipment (UE) based on the determined set of resources for the EPBCH.

Certain aspects of the present disclosure provide a method for wireless communications by a base station user equipment (UE). The method generally includes determining a set of resources for an enhanced physical broadcast channel (EPBCH), wherein the set of resources is the same as those for a legacy physical broadcast channel (PBCH) and processing an EPBCH from a base station based on the determined set of resources for the EPBCH.

Certain aspects of the present disclosure provide a method for wireless communications by a base station user equipment (UE). The method generally includes receiving an enhanced physical broadcast channel (EPBCH) transmitted from a BS using a frequency division multiplexed (FDM) structure, wherein the EPBCH spans substantially a subframe duration; and processing the EPBCH.

Certain aspects of the present disclosure also provide apparatuses and program products for performing the operations described above.

### BRIEF DESCRIPTION OF THE DRAWINGS

FIG. 1 is a block diagram conceptually illustrating an example wireless communication network, in accordance with certain aspects of the present disclosure.

FIG. 2 is a block diagram conceptually illustrating an example of an evolved node B (eNB) in communication with a user equipment (UE) in a wireless communications network, in accordance with certain aspects of the present disclosure.

FIG. 3 is a block diagram conceptually illustrating an example frame structure for a particular radio access technology (RAT) for use in a wireless communications network, in accordance with certain aspects of the present disclosure.

FIG. 4 illustrates example subframe formats for the downlink with a normal cyclic prefix (CP), in accordance with certain aspects of the present disclosure.

FIG. 5 illustrates an example physical broadcast channel (PBCH) format.

FIG. 6 illustrates an example frequency division multiplexing (FDM)-based PBCH format, in accordance with certain aspects of the present disclosure.

FIG. 7 illustrates an example PBCH format with interleaving, in accordance with certain aspects of the present disclosure.

FIGS. 8A and 8B illustrates an example PBCH formats, in accordance with certain aspects of the present disclosure.

FIG. 9 illustrates example operations for a base station, in accordance with certain aspects of the present disclosure.

FIG. 10 illustrates example operations for a user equipment (UE), in accordance with certain aspects of the present disclosure.

FIG. 11 illustrates example operations for a base station, in accordance with certain aspects of the present disclosure.

FIG. 12 illustrates example operations for a user equipment (UE), in accordance with certain aspects of the present disclosure.

### DETAILED DESCRIPTION

Aspects of the present disclosure provide techniques and apparatus for enhanced physical broadcast channel (PBCH) for new carrier type (NCT) in long term evolution (LTE).

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “network” and “system” are often used interchangeably. A CDMA network may implement a radio technology such as Universal Terrestrial Radio Access (UTRA), cdma2000, etc. UTRA includes Wideband-CDMA (W-CDMA), Time Division Synchronous CDMA (TD-SCDMA), and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A), in both frequency division duplex (FDD) and time division duplex (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE/LTE-A, and LTE/LTE-A terminology is used in much of the description below.

### An Example Wireless Communication System

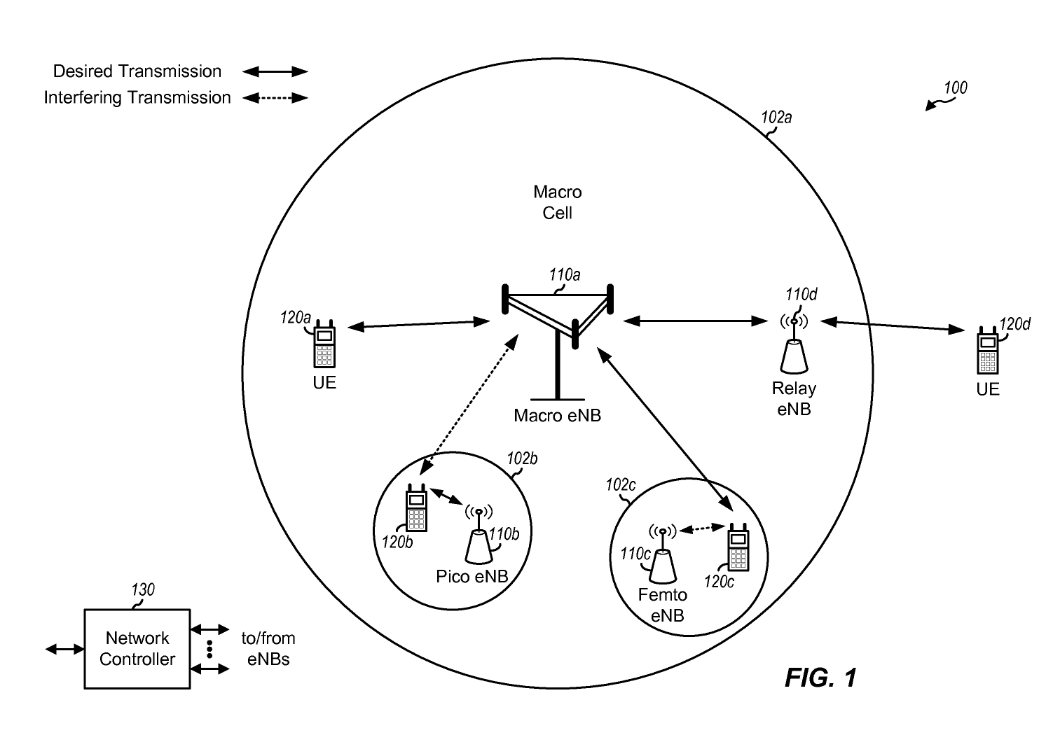

FIG. 1 shows a wireless communication network 100, which may be an LTE network or some other wireless network. Wireless network 100 may include a number of evolved Node Bs (eNBs) 110 and other network entities. An eNB is an entity that communicates with user equipments (UEs) and may also be referred to as a base station, a Node B, an access point (AP), etc. Each eNB may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). An eNB for a macro cell may be referred to as a macro eNB. An eNB for a pico cell may be referred to as a pico eNB. An eNB for a femto cell may be referred to as a femto eNB or a home eNB (HeNB). In the example shown in FIG. 1, an eNB 110a may be a macro eNB for a macro cell 102a, an eNB 110b may be a pico eNB for a pico cell 102b, and an eNB 110c may be a femto eNB for a femto cell 102c. An eNB may support one or multiple (e.g., three) cells. The terms “eNB”, “base station,” and “cell” may be used interchangeably herein.

Wireless network 100 may also include relay stations. A relay station is an entity that can receive a transmission of data from an upstream station (e.g., an eNB or a UE) and send a transmission of the data to a downstream station (e.g., a UE or an eNB). A relay station may also be a UE that can relay transmissions for other UEs. In the example shown in FIG. 1, a relay station 110d may communicate with macro eNB 110a and a UE 120d in order to facilitate communication between eNB 110a and UE 120d. A relay station may also be referred to as a relay eNB, a relay base station, a relay, etc.

Wireless network 100 may be a heterogeneous network that includes eNBs of different types, e.g., macro eNBs, pico eNBs, femto eNBs, relay eNBs, etc. These different types of eNBs may have different transmit power levels, different coverage areas, and different impact on interference in wireless network 100. For example, macro eNBs may have a high transmit power level (e.g., 5 to 40 W) whereas pico eNBs, femto eNBs, and relay eNBs may have lower transmit power levels (e.g., 0.1 to 2 W).

A network controller 130 may couple to a set of eNBs and may provide coordination and control for these eNBs. Network controller 130 may communicate with the eNBs via a backhaul. The eNBs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station (MS), a subscriber unit, a station (STA), etc. A UE may be a cellular phone, a personal digital assistant (PDA), a wireless modem, a wireless communication device, a handheld device, a laptop computer, a cordless phone, a wireless local loop (WLL) station, a tablet, a smart phone, a netbook, a smartbook, etc.

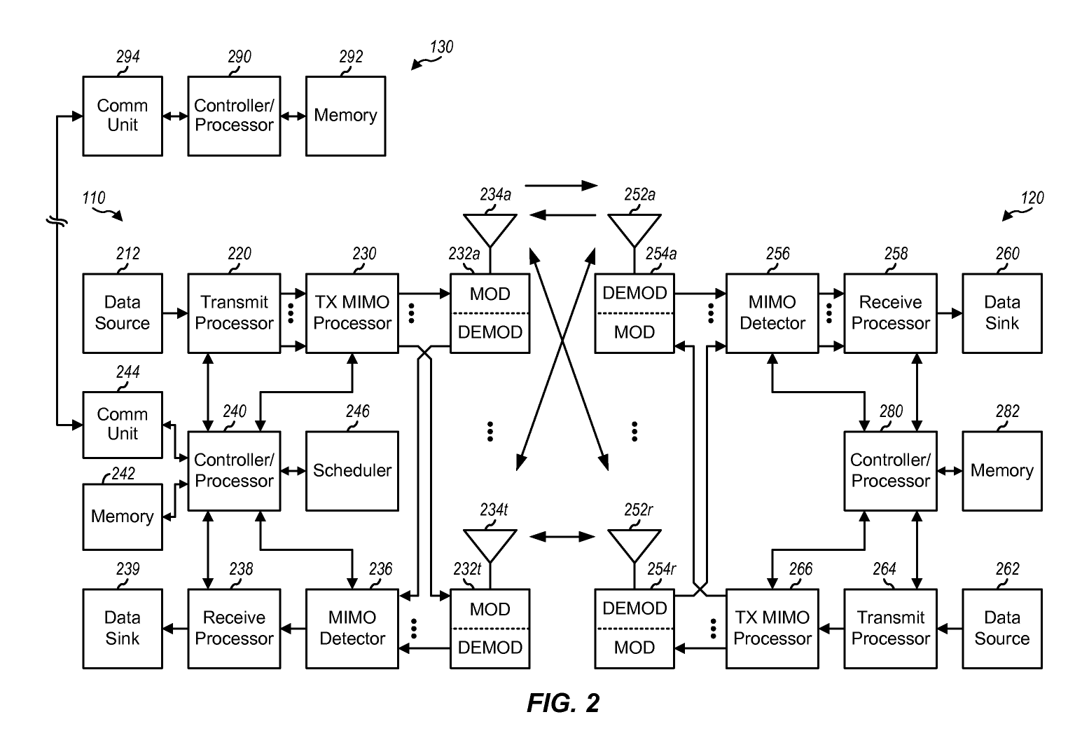

FIG. 2 is a block diagram of a design of base station/eNB 110 and UE 120, which may be one of the base stations/eNBs and one of the UEs in FIG. 1. Base station 110 may be equipped with T antennas 234a through 234t, and UE 120 may be equipped with R antennas 252a through 252r, where in general T≧1 and R≧1.

At base station 110, a transmit processor 220 may receive data from a data source 212 for one or more UEs, select one or more modulation and coding schemes (MCSs) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI), etc.) and control information (e.g., CQI requests, grants, upper layer signaling, etc.) and provide overhead symbols and control symbols. Processor 220 may also generate reference symbols for reference signals (e.g., the common reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) its received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), CQI, etc.

On the uplink, at UE 120, a transmit processor 264 may receive and process data from a data source 262 and control information (e.g., for reports comprising RSRP, RSSI, RSRQ, CQI, etc.) from controller/processor 280. Processor 264 may also generate reference symbols for one or more reference signals. The symbols from transmit processor 264 may be precoded by a TX MIMO processor 266 if applicable, further processed by modulators 254a through 254r (e.g., for SC-FDM, OFDM, etc.), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

Controllers/processors 240 and 280 may direct the operation at base station 110 and UE 120, respectively. Processor 240 and/or other processors and modules at base station 110, and/or processor 280 and/or other processors and modules at UE 120, may perform or direct processes for the techniques described herein. Memories 242 and 282 may store data and program codes for base station 110 and UE 120, respectively. A scheduler 246 may schedule UEs for data transmission on the downlink and/or uplink.

When transmitting data to the UE 120, the base station 110 may be configured to determine a bundling size based at least in part on a data allocation size and precode data in bundled contiguous resource blocks of the determined bundling size, wherein resource blocks in each bundle may be precoded with a common precoding matrix. That is, reference signals (RSs) such as UE-RS and/or data in the resource blocks may be precoded using the same precoder. The power level used for the UE-RS in each resource block (RB) of the bundled RBs may also be the same.

The UE 120 may be configured to perform complementary processing to decode data transmitted from the base station 110. For example, the UE 120 may be configured to determine a bundling size based on a data allocation size of received data transmitted from a base station in bundles of contiguous RBs, wherein at least one reference signal in resource blocks in each bundle are precoded with a common precoding matrix, estimate at least one precoded channel based on the determined bundling size and one or more RSs transmitted from the base station, and decode the received bundles using the estimated precoded channel.

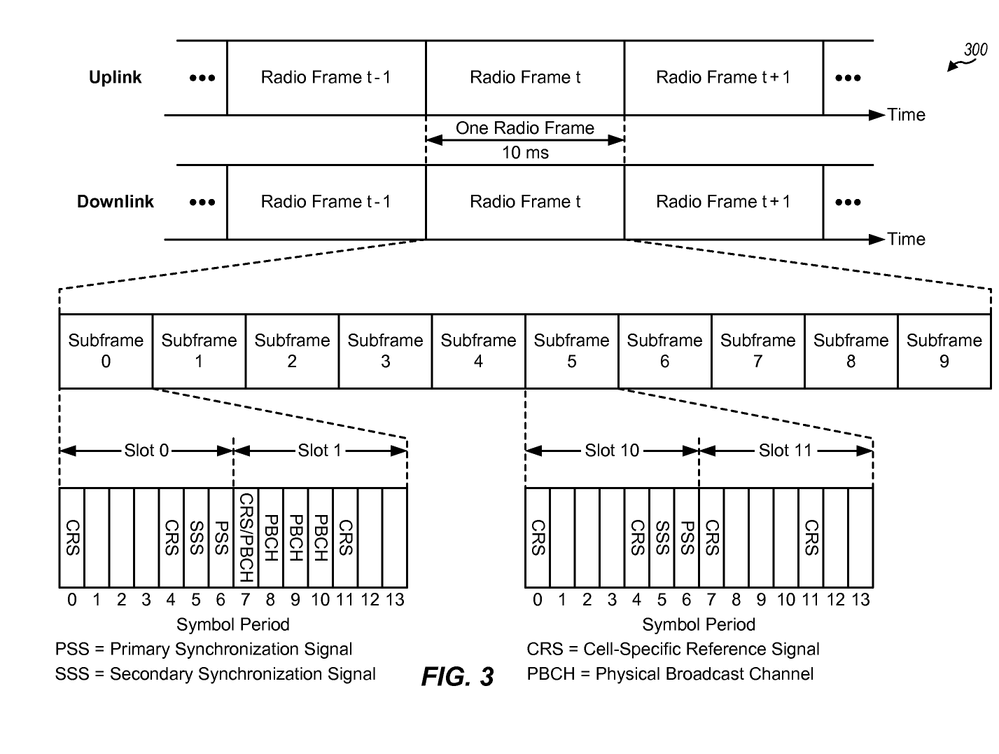

FIG. 3 shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 2) or six symbol periods for an extended cyclic prefix. The 2L symbol periods in each subframe may be assigned indices of 0 through 2L−1.

In LTE, an eNB may transmit a primary synchronization signal (PSS) and a secondary synchronization signal (SSS) on the downlink in the center 1.08 MHz of the system bandwidth for each cell supported by the eNB. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. The eNB may transmit a cell-specific reference signal (CRS) across the system bandwidth for each cell supported by the eNB. The CRS may be transmitted in certain symbol periods of each subframe and may be used by the UEs to perform channel estimation, channel quality measurement, and/or other functions. The eNB may also transmit a physical broadcast channel (PBCH) in symbol periods 0 to 3 in slot 1 of certain radio frames. The PBCH may carry some system information. The eNB may transmit other system information such as system information blocks (SIBs) on a physical downlink shared channel (PDSCH) in certain subframes. The eNB may transmit control information/data on a physical downlink control channel (PDCCH) in the first B symbol periods of a subframe, where B may be configurable for each subframe. The eNB may transmit traffic data and/or other data on the PDSCH in the remaining symbol periods of each subframe.

The PSS, SSS, CRS, and PBCH in LTE are described in 3GPP TS 36.211, entitled “Evolved Universal Terrestrial Radio Access (E-UTRA); Physical Channels and Modulation,” which is publicly available.

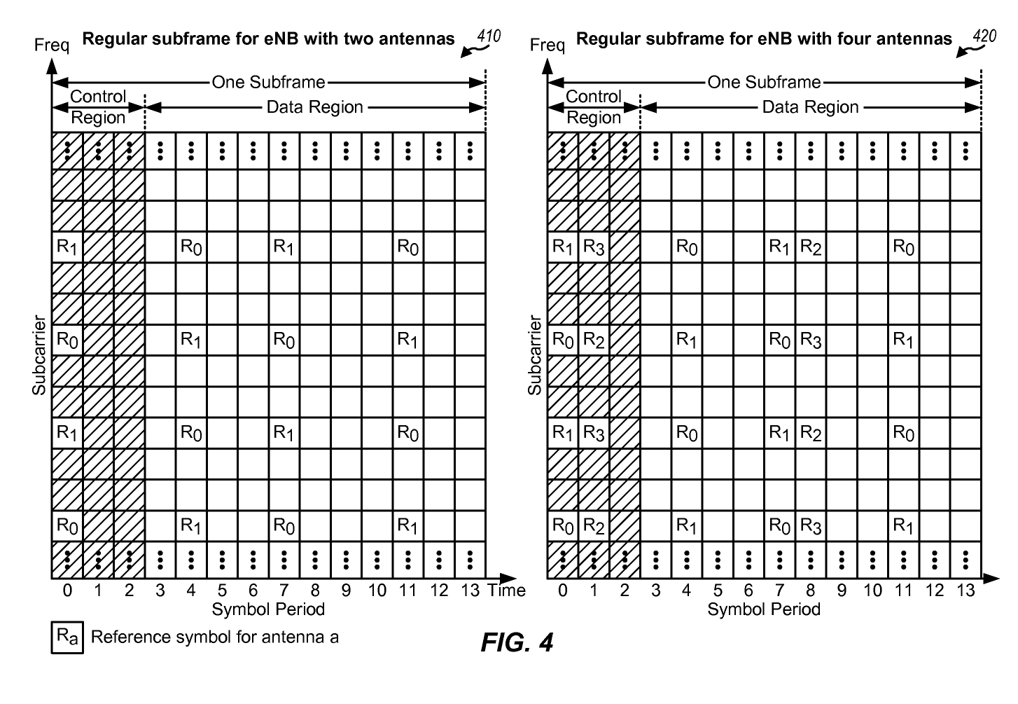

FIG. 4 shows two example subframe formats 410 and 420 for the downlink with a normal cyclic prefix. The available time frequency resources for the downlink may be partitioned into resource blocks. Each resource block may cover 12 subcarriers in one slot and may include a number of resource elements. Each resource element may cover one subcarrier in one symbol period and may be used to send one modulation symbol, which may be a real or complex value.

Subframe format 410 may be used for an eNB equipped with two antennas. A CRS may be transmitted from antennas 0 and 1 in symbol periods 0, 4, 7, and 11. A reference signal is a signal that is known a priori by a transmitter and a receiver and may also be referred to as pilot. A CRS is a reference signal that is specific for a cell, e.g., generated based on a cell identity (ID). In FIG. 4, for a given resource element with label Ra, a modulation symbol may be transmitted on that resource element from antenna a, and no modulation symbols may be transmitted on that resource element from other antennas. Subframe format 420 may be used for an eNB equipped with four antennas. A CRS may be transmitted from antennas 0 and 1 in symbol periods 0, 4, 7, and 11 and from antennas 2 and 3 in symbol periods 1 and 8. For both subframe formats 410 and 420, a CRS may be transmitted on evenly spaced subcarriers, which may be determined based on cell ID. Different eNBs may transmit their CRSs on the same or different subcarriers, depending on their cell IDs. For both subframe formats 410 and 420, resource elements not used for the CRS may be used to transmit data (e.g., traffic data, control data, and/or other data).

An interlace structure may be used for each of the downlink and uplink for FDD in LTE. For example, Q interlaces with indices of 0 through Q−1 may be defined, where Q may be equal to 4, 6, 8, 10, or some other value. Each interlace may include subframes that are spaced apart by Q frames. In particular, interlace q may include subframes q, q+Q, q+2Q, etc., where qε{0, . . . , Q−1}.

The wireless network may support hybrid automatic retransmission request (HARQ) for data transmission on the downlink and uplink. For HARQ, a transmitter (e.g., an eNB 110) may send one or more transmissions of a packet until the packet is decoded correctly by a receiver (e.g., a UE 120) or some other termination condition is encountered. For synchronous HARQ, all transmissions of the packet may be sent in subframes of a single interlace. For asynchronous HARQ, each transmission of the packet may be sent in any subframe.

A UE may be located within the coverage of multiple eNBs. One of these eNBs may be selected to serve the UE. The serving eNB may be selected based on various criteria such as received signal strength, received signal quality, path loss, etc. Received signal quality may be quantified by a signal-to-interference-plus-noise ratio (SINR), or a reference signal received quality (RSRQ), or some other metric. The UE may operate in a dominant interference scenario in which the UE may observe high interference from one or more interfering eNBs.

### Downlink Coverage Issues

According to certain systems (e.g., in LTE Rel-8/9/10/11), PBCH is transmitted with a 40-bit payload size. The 40-bit payload consists of an 8-bit system frame number (SFN), a 3-bit physical HARQ information channel (PHICH) information (including the size of PHICH region and whether PHICH is of an extended duration or not), a 4-bit system bandwidth, 9 reserved bits, and a 16-bit cyclic redundancy check (CRC). PBCH also conveys cell-specific reference signal (CRS) antenna configuration via different CRC masks; 3 CRC masks are defined to convey information about {1, 2, or 4} CRS antenna ports. PBCH is transmitted every 10 ms, but the same information is transmitted in four consecutive transmission opportunities (TxOps), resulting in a 40 ms periodicity for PBCH information update (40 ms PBCH transmission time interval (TTI)). As shown in FIG. 3, PBCH is transmitted using the first four symbols in the second slot of subframe 0 in the center 6 resource blocks (RBs), excluding the resource elements (REs) potentially used by CRS (e.g., always assuming 4-port CRS, irrespective of the actual CRS port configuration).

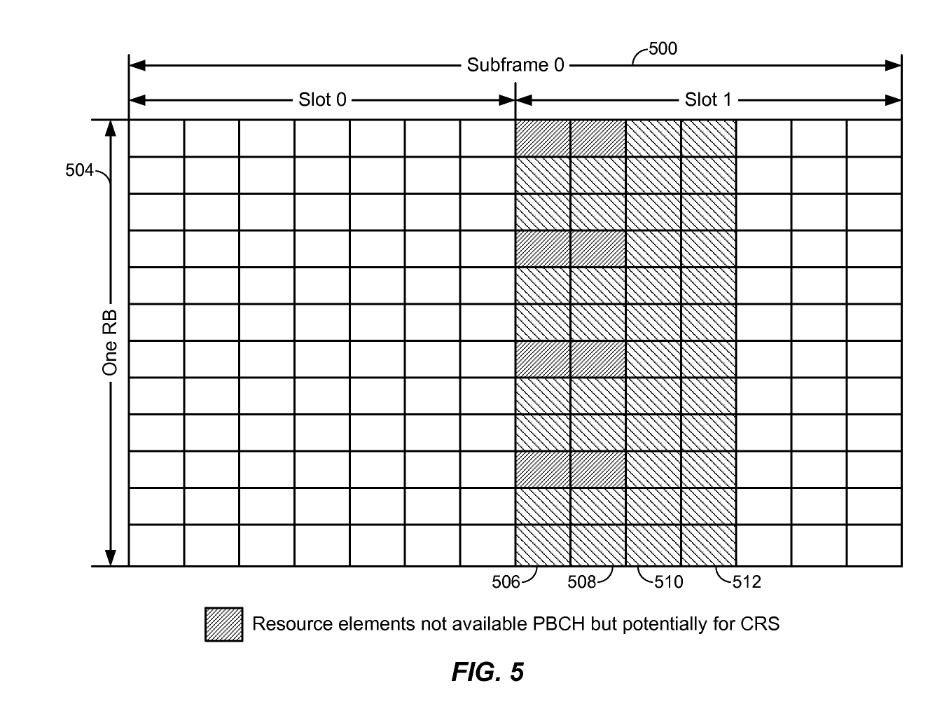

FIG. 5 illustrates an example PBCH format. In the example shown in FIG. 5, normal cyclic prefix (CP), frequency shift for CRS is zero, REs occupied by PBCH are illustrated for one of the 6 RBs for PBCH. As shown, REs potentially used for CRS are not available for PBCH. As shown in FIG. 5, the number of REs for PBCH is 6 (RBs)×(4 (symbols 506, 508, 510, 512)×12 (subcarriers in one RB 504)−8 (unavailable REs))=240 in one subframe 500.

In certain systems, a New Carrier Type (NCT) will be defined (i.e. in LTE Rel-12). NCT may at least be supported in the context of carrier aggregation (CA) as secondary carriers. If justified, standalone NCT may also be supported. NCT has reduced CRS overhead. For example, CRS may be transmitted only once every 5 ms instead of in every subframe as in legacy carrier type (LCT). CRS may also be transmitted in NCT using 1 port only instead of up to 4 CRS ports as in LCT. In NCT, may be used for time/frequency tracking and possibly reference signal received power (RSRP) measurement and may not be used for demodulation. For NCT in CA as secondary carriers, PBCH may not be used, since the relevant information in PBCH can be tunneled to the user equipment (UE) via dedicated signaling. However, for standalone NCT, PBCH may be desired.

Accordingly, it is desirable to define PBCH for NCT.

Issues related to PBCH with NCT may include how to support PBCH, what information should be carried in PBCH, whether and how PBCH should be used for the first phase of NCT (where NCT is part of carrier aggregation as secondary carriers), if PBCH is decided to be omitted, and design considerations for future compatibility. Aspects of the present disclosure may address these issues.

In the remainder of this disclosure, a PBCH for NCT will be generally referred to as enhanced PBCH or EPBCH for convenience. PBCH for LCT may be generally referred to simply as PBCH.

### Example EPBCH

According to certain aspects, enhanced physical broadcast channel (EPBCH) may occupy 4 symbols in center 6 resource blocks (RBs)—the same as legacy PBCH. Cyclic redundancy check (CRC) scrambling may be different from legacy PBCH in order to differentiate new carrier type (NCT) from legacy carrier type (LCT) (e.g., using a different scrambling sequence). The scrambling for EPBCH data may be done differently from that of PBCH as well.

According to certain aspects, EPBCH may be based on frequency-division multiplexing (FDM). According to certain systems (e.g., LTE Rel-11), enhanced physical downlink control channel (EPDCCH) may be supported in NCT while legacy PDCCH may not be supported in NCT. EPDCCH has a FDM structure. Physical downlink shared channel (PDSCH) may follow a FDM structure as well. Thus, to better integrate EPBCH with EPDCCH and PDSCH, an FDM structure for EPBCH may be used.

According to certain aspects, if EPBCH is transmitted in the same subframes as a primary synchronization signal (PSS), secondary synchronization signal (SSS), cell-specific reference signal (CRS), or demodulation reference signal (DM-RS) (for EPBCH), the resource elements (REs) occupied by these other signals may be excluded from EPBCH transmission. However, space-frequency block code (SFBC) may not be supported for EPBCH—as it is for legacy PBCH. As a result, instead of assuming 4-port CRS, irrespective of the actual CRS configuration—as in legacy PBCH—, EPBCH may consider the actual CRS configuration and exclude only REs for the actual CRS. In some embodiments, there may be only one CRS configuration in NCT which, for example, may have only 1-port configured for CRS.

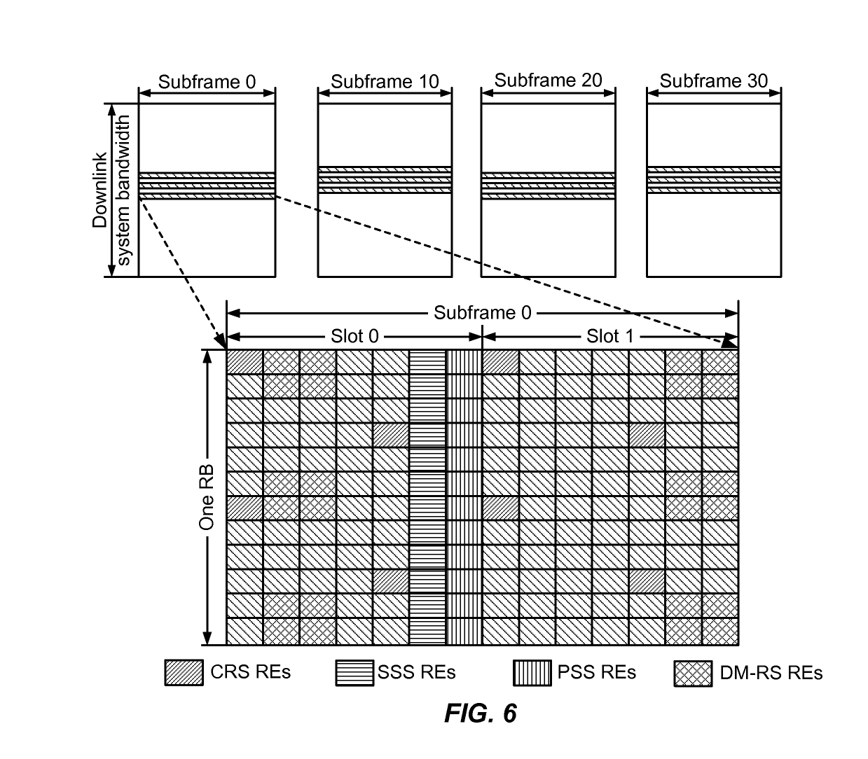

FIG. 6 illustrates an example frequency division multiplexing (FDM)-based PBCH format, in accordance with certain aspects of the present disclosure. As shown in FIG. 6, assuming 3 RBs for EPBCH, the 3RBs may be located within the center 6 RBs but the actual locations may hop (e.g., from subframe 0 to subframe 10, subframe 10 to subframe 20, and subframe 20 to subframe 30). Within a PRB pair, REs occupied by CRS/PSS/SSS/DM-RS may be excluded. The DM-RS pattern illustrated in FIG. 6 is just one example (actual DM-RS pattern may be different).

### Number of Resource Blocks

According to certain aspects, EPBCH resource blocks (RBs) may have a similar number of REs as legacy PBCH. If the payload size of EPBCH is different from PBCH (e.g., greater than 40 bits), the number of RBs may be revised accordingly. In one example, for normal CP, legacy PBCH may be over 240 REs per transmission. For EPBCH, the number of REs per physical resource block (PRB) pair may be:

(14*12)−(2*12(PSS/SSS))−(2*4(1-port CRS))>(N(DM-RS))=(136−N),

REs, where N is a number of assumed additional DM-RS REs. Therefore, in the current example, 2 PRB pairs for EPBCH may be desirable.

### Location

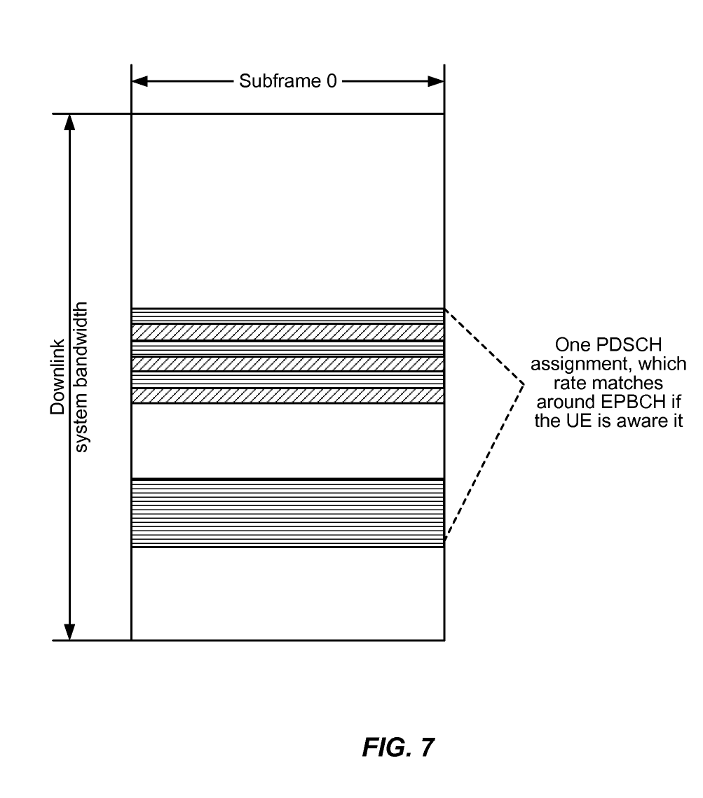

According to certain aspects, the N RBs for FDM EPBCH may be within the center 6 RBs. If N is less than 6, the subset of RBs may be interleaved for improved frequency diversity—instead of a block manner (e.g., N consecutive RBs)—as shown in FIG. 7. If PDSCH is scheduled with PRB pairs overlapped with EPBCH PRB pairs, the overlapped EPBCH PRB pairs may be excluded from PDSCH by UEs which are aware of EPBCH.

According to certain aspects, the location of the N RBs for FDM-based EPBCH may be cell-independent, thus, EPBCHs may collide. Interference cancellation may be performed to avoid collisions.

Alternatively, the location of the N RBs for FDM-based EPBCH may be cell-dependent, allowing EPBCH reuse across cells. For example, if N=2, a reuse factor of ⅓ can be achieved. The following provides an example of reuse with the following parameters: N=2 RBs for EPBCH, the center 6 RBs are indexed as RBs 0, 1, 2, 3, 4, and 5. According to certain aspects, EPBCH for cell 1 may be mapped RBs 0 and 3, EPBCH for cell 2 may be mapped to RBs 1 and 4, and EPBCH for cell 3 may be mapped to RBs 2 and 5. This mapping may allow reuse across cells. The use of interleaved RBs (e.g., 0 and 3 instead of 0 and 1), as illustrated in FIG. 7 for example, may also improve frequency diversity.

According to certain aspects, when the location of the N RBs is cell-dependent, UEs may detect the reuse across the cells. The UEs may detect this based on a linkage between the cell ID and block numbers, or by means of a blind detection algorithm. As an example, to determine the subset of the N RBs within the center 6 RBs for EPBCH for a particular cell, either some blind detection can be done at the UE, or some implication linkage (e.g., based on cell ID) can be done. The UE may detect whether RBs 0/2/4 or 1/3/5 are used for a cell. As another example, the UE may determine the location of EPBCH based on the cell ID detection via PSS/SSS (e.g., even cell ID values indicate RBs 0/2/4 and odd cell ID values indicate RBs 1/3/5 for EPBCH).

According to certain aspects, when the location of the N RBs is cell-dependent, for coordinated multipoint (CoMP) with NCT, the EPBCH location may signaled in PDSCH rate matching and quasi-co-location indication (PQI) as part of CoMP operation—ether explicitly or implicitly.

Referring back to FIG. 6, the location of the RBs for EPBCH in one EPBCH transmission time interval (TTI) may be the same or different. According to certain aspects, the location may be varied according to the cell number, randomizing inter-cell EPBCH interference. As an example, assuming the same 10 ms based EPDCCH transmission with a 40 ms TTI, the 4 transmissions in one TTI can have the same set of RBs or different sets of RBs. If different set of RBs is supported, the hopping can be pre-determined. One example is illustrated in FIG. 6 RBs 0/2/4 for the first transmission in the TTI, RBs 1/3/5 for the second transmission in the TTI, RBs 0/2/4 for the third transmission in the TTI, and RBs 1/3/5 for fourth transmission in the TTI.

### Reference Signal (RS) Design

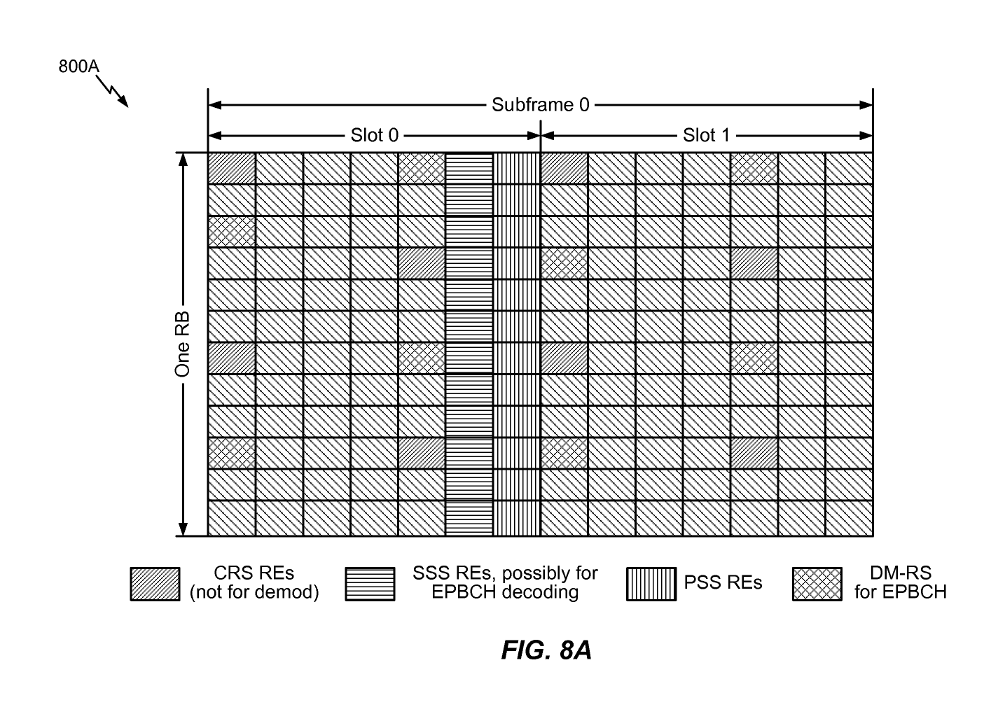

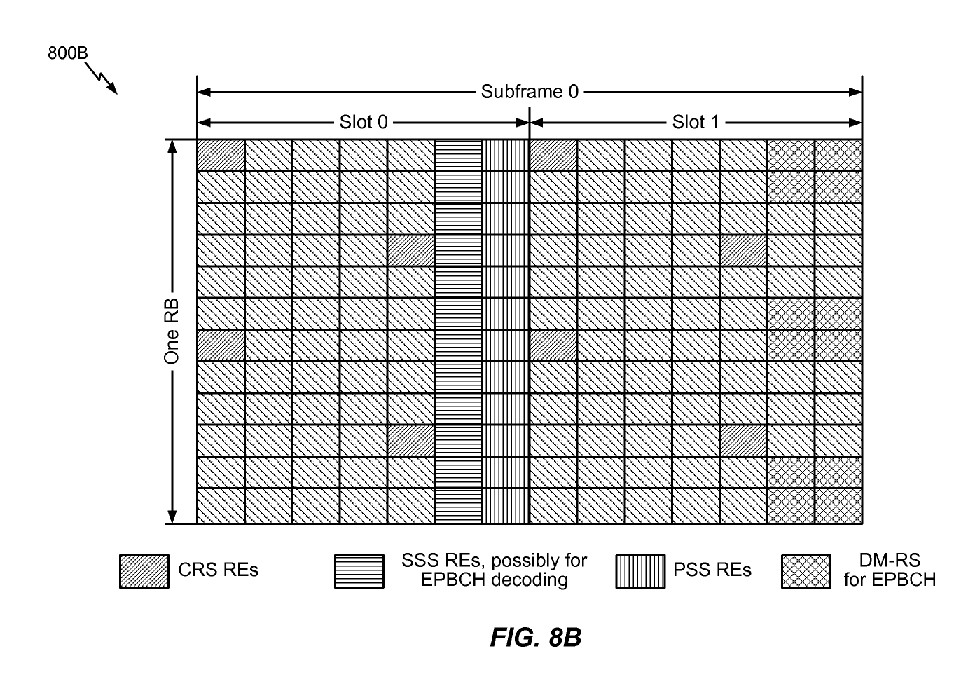

FIGS. 8A and 8B illustrate example PBCH formats 800A, 800B with different locations for DM-RS and other signals, in accordance with certain aspects of the present disclosure. According to certain aspects, the locations of DM-RS for EPBCH may be fixed. Alternatively, the locations of DM-RS for EPBCH may be cell-dependent, which may reduce EPBCH false alarm detection by UEs. In certain embodiments, a scrambling sequence for DM-RS may be a function of cell ID.

In certain embodiments, some REs originally used for CRS may be used for EPBCH DM-RS. In certain embodiments, SSS may be used for EPBCH decoding, possibly combined with the dedicated RS for EPBCH decoding. For example, SSS may serve as one antenna port, while DM-RS may serve as another antenna port for beam cycling.

In certain embodiments, if a cell only has one physical antenna port, two virtual DM-RS ports for EPBCH may be advertised, both using the same physical antenna port.

According to certain aspects, REs may be reserved for EPBCH to prevent PDSCH/EPDCCH from mapping to them. For legacy-based EPBCH design, the REs may be reserved for EPBCH since the remaining REs in the PRB pairs carrying EPBCH may not be easily reused by PDSCH/EPDCCH. In that case, PDSCH and/or EPDCCH would not map its resource to these reserved REs even if there is no actual EPBCH transmission. Alternatively, the entire PRB pair may be excluded for PDSCH/EPDCCH even if only part of the resources in the PRB pair is to be used for EPBCH. Another alternative is to completely ignore possible EPBCH transmissions in the center 6 RBs, and PDSCH/EPDCCH may be scheduled in these RBs will not rate match to any REs of these RBs.

For the FDM-based EPBCH, it is also possible to have resource reservation for EPBCH for future proofing. However, according to certain aspects, reservation of REs for EPBCH may be omitted, since FDM based structure makes it easier to dedicate some RBs in future for EPBCH, transparent to earlier design.

### Contents of PBCH

According to certain aspects, the 3-bit PHICH information may be removed from EPBCH. According to certain aspects, if EPHICH is supported in NCT (e.g., multiplexed with EPDCCH), EPHICH information (e.g., size, location, etc.) may be conveyed by EPBCH. In certain embodiments, some information on common search space for EPDCCH (e.g., size, location, etc.) may be conveyed by EPBCH (e.g., to facilitate SIB1 decoding).

According to certain aspects, the EPBCH payload size may be different from the PBCH payload size, allowing additional information to be conveyed in EPBCH which may enrich the information in PBCH. For example, the EPBCH payload may include some information originally conveyed in system information blocks (SIBs). In certain embodiments, EPBCH may carry SIB-lite information.

According to certain aspects, the CRC for PBCH may not be scrambled by CRS-port information. Instead, CRS may be scrambled differently in order to distinguish EPBCH from PBCH. For certain embodiments, CRC may have different sequences for standalone NCT operation and NCT as secondary cell operations, to prevent early decoding of SIB information. For certain embodiments, the CRC may not be scrambled by other information at all. Alternatively, the CRC may be scrambled to convey other information. For example, CRC may be scrambled to convey a number of DM-RS ports, a number of CSI-RS ports and/or locations, etc. The scrambling sequence for EPBCH can be the same or different from that of legacy PBCH.

According to certain aspects, the same modulation and coding as PBCH may be used for EPBCH. For example, quadrature phase shift keying (QPSK) and tail biting convolution coding (TBCC) may be used. However, if the payload size is large (e.g., greater than 40 bits), regular CC coding may be used instead of using TBCC.

According to certain aspects, transmission time interval (TTI) period for EPBCH may also be the same as legacy PBCH (e.g., 40 ms). Other TTI values may be used as well (e.g., 80 ms). As an example, in order to ensure a reuse factor of ⅓ for FDM-based EPBCH, EPBCH may use more than 2 RBs and a longer TTI to ensure good coverage of PBCH if the payload size is larger than 40 bits. A longer TTI may incur more UE complexity for blind detection of the start of the TTI and may also impact the system frame number (SFN) bitwidth in EPBCH. As an example, with 80 ms TTI, the UE may have to perform 8 hypotheses detection to determine the start of the TTI. Accordingly, the number of bits for SFN conveyed in EPBCH can be reduced from 8 bits to 7 bits.

According to certain aspects, the periodicity for EPBCH transmissions may be the same or different from 10 ms. As an example, a 5 ms periodicity is possible in order to align with PSS/SSS. As another example example, a periodicity of 20 ms may allow more reuse across cells.

According to certain aspects, the CRS scrambling sequence periodicity may be extended from 10 ms to 40 ms (e.g., aligning it with EPBCH TTI), such that the starting frame for EPBCH may be determined based on CRS sequence.

According to certain aspects, the subframe offset for EPBCH may be fixed across cells. For example, the offset may be fixed at 0, such that EPBCH may be transmitted in subframe 0 in all cells. Alternatively, the subframe offset for EPBCH may be different across cells. For example, the subframe offset for cell 1 may be 0, such that EPBCH may be transmitted in subframe 0 every 10 ms by cell 1, while the subframe offset for cell 2 may be 5, such that EPBCH may be transmitted in subframe 5 every 10 ms by cell 2. The determination of the subframe offset for EPBCH in a cell may be by blind detection at the UE or based on cell ID of the cell, where the cell ID may be determined based on PSS/SSS.

### Interaction with CSI-RS

In Rel-10/11, if channel state information (CSI) RS collides PBCH, CSI-RS will be dropped. However, some CSI-RS patterns that do not collide with PBCH may be selected such that both CSI-RS and PBCH may be transmitted in a same subframe. For FDM-based EPBCH, it is no longer possible to find a non-colliding CSI-RS pattern. According to certain aspects, if CSI-RS collides with EPBCH, the entire CSI-RS may be dropped, for example, due to FDM structure for EPBCH that CSI-RS may not be transmitted in EPBCH subframes.

Alternatively, only CSI-RS in the EPBCH PRB pairs may be dropped, but the remaining CSI-RS may be transmitted in other non-EPBCH PRB pairs. Channel/interference estimation may exclude the EPBCH PRB pairs in EPBCH subframes. For certain embodiments, the center 6 RBs may be excluded for CSI-RS in an EPBCH subframe even if EPBCH in a cell only occupies a subset of the 6 RBs.

As another alternative, CSI-RS may be transmitted, and puncture some REs for EPBCH transmission.

### Interaction with PMCH

According to certain aspects, EPBCH may collide with physical multicast channel (PMCH). For certain embodiments, PMCH may not be allowed in EPBCH subframes. Alternatively, PMCH may exclude PRB pairs occupied by EPBCH or may exclude the center 6 PRB pairs. For certain embodiments, guard tones may be placed in between EPBCH and PMCH.

### Interaction with PRS

According to certain aspects, positioning reference signal (PRS) and EPBCH may collide. In that case, EPBCH may puncture PRS. Alternatively, PRS may puncture EPBCH. For certain embodiments, the entire PRS may be dropped or dropped in the center 6 PRB pairs.

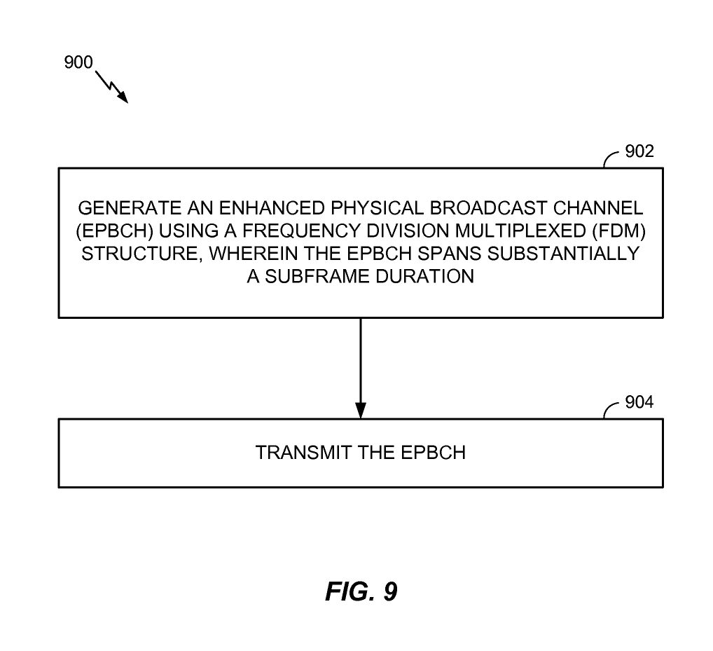

FIG. 9 illustrates example operations 900 for wireless communications, in accordance with certain aspects of the present disclosure. The operations 900 may be performed, for example, by a BS (e.g., BS 110) and may begin at 902 by generating an enhanced physical broadcast channel (EPBCH) using a frequency division multiplexed (FDM) structure, wherein the EPBCH spans substantially a subframe duration.

According to certain aspects, EPBCH resources may be assigned based on actual CRS configurations. For certain embodiments, a number of RBs spanned by the EPBCH may be less than a number of RBs spanned by a legacy PBCH.

At 904, the BS may transmit the EPBCH. According to certain aspects, the EPBCH may be transmitted in a same subframe as one or more of a PSS, a SSS, a CRS, or a DM-RS, and REs occupied by the one or more of these signals may be excluded from the EPBCH transmission. For certain embodiments, at least one PRB pair is used for the EPBCH transmission. For example, the at least one PRB pair used for EPBCH may be within a center 6 PRB pairs. For certain embodiments, at least two PRB pairs may be used for the EPBCH transmission and the at least two PRB pairs for EPBCH may be physically non-consecutive. If PDSCH is scheduled with PRB pairs that overlap with EPBCH PRB pairs, the overlapped EPBCH PRB pairs may be excluded from PDSCH by a UE. A location of the at least one PRB pair for the EPBCH may be cell-independent or cell-dependent. For certain embodiments, if the location is cell-dependent, locations of the at least one PRB pair for the EPBCH may be re-used among cells.

According to certain aspects, the same EPBCH information may be transmitted multiple times in an EPBCH TTI period. For certain embodiments, the location of the at least one PRB pair for EPBCH may be different for different transmissions within an EPBCH TTI period. For example, the locations may change according to a hopping pattern (e.g., a cell-specific hopping pattern). A subframe offset for the EPBCH transmission may also be cell-specific. A CRS scrambling sequence periodicity may be used to indicate a starting frame for EPBCH. According to certain aspects, the BS may perform interference cancellation to alleviate collisions with EPBCH from other cells.

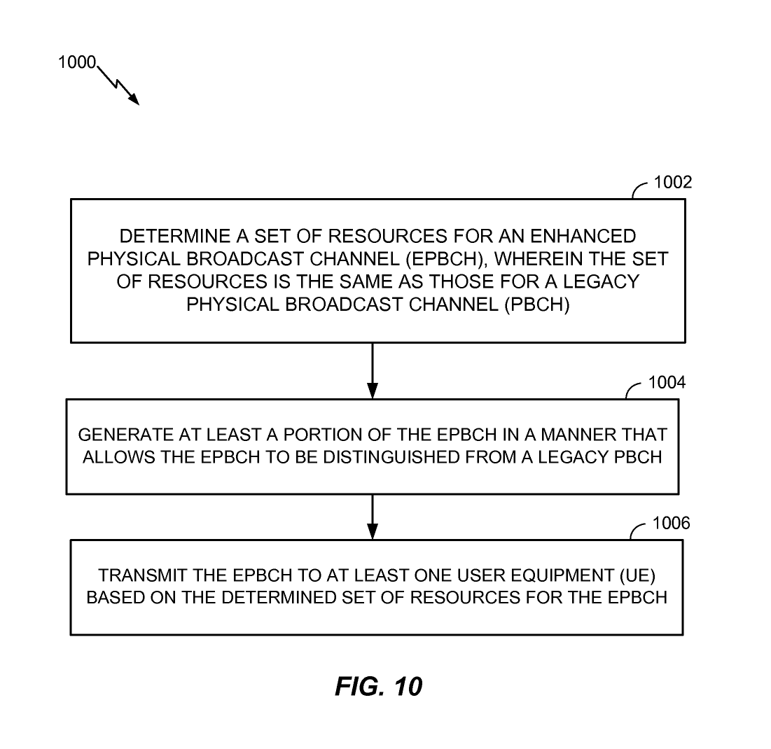

FIG. 10 illustrates example operations 1000 for wireless communications, in accordance with certain aspects of the present disclosure. The operations 1000 may be performed, for example, by a base station (e.g., base station 110) and may begin, at 1002, by determining a set of resources for an EPBCH, wherein the set of resources is the same as those for a legacy PBCH.

At 1004, the BS may generate at least a portion of the EPBCH in a manner that allows the EPBCH to be distinguished from a legacy PBCH. For example, a CRC value of the EPBCH may be scrambled in a manner that is different than a CRC of a legacy PBCH. In another example, a portion of information carried in the EPBCH (which may be different than information carried legacy PBCH) may be scrambled in a manner that allows the EPBCH to be distinguished from the legacy PBCH.

At 1006, the BS may transmit the EPBCH to at least one user equipment (UE) based on the determined set of resources for the EPBCH.

According to certain aspects, the BS may exclude PRB for PDSCH/EPDCCH if any part of the resources in the PRB pair is to be used for EPBCH. According to certain aspects, the BS may utilize a SSS as a reference signal for EPBCH. For certain embodiments, the BS may utilize one or more REs corresponding to a CRS to convey a reference signal for EPBCH.

According to certain aspects, the BS may refrain from sending EPBCH, but the set of REs for EPBCH may be reserved. For certain embodiments, the BS may avoid mapping downlink channels to the reserved REs. For certain embodiments, the EPBCH may be transmitted in a carrier that is a secondary carrier as part of a carrier aggregation of two or more carriers. For certain embodiments, the EBPCH may carry at least one of a location of a common search space, a size of a common search space, a location of an enhanced hybrid acknowledgement channel, and a size of a enhanced hybrid acknowledgement channel.

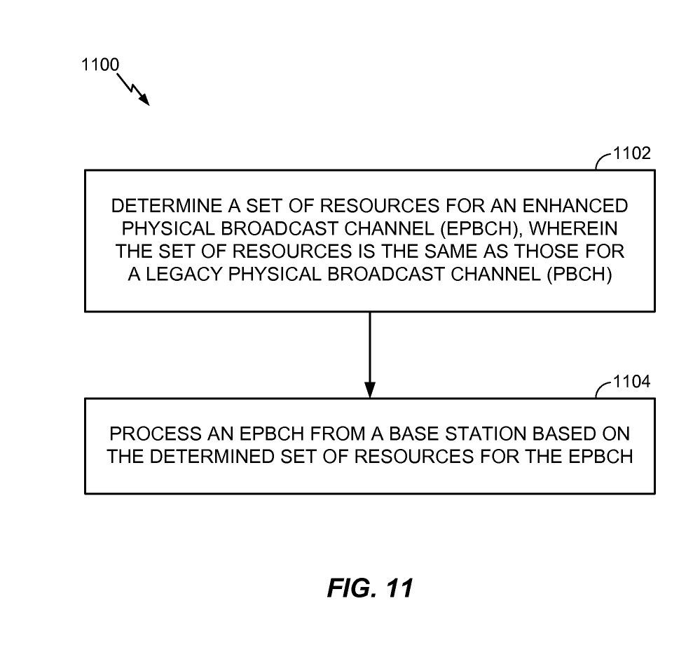

FIG. 11 illustrates example operations 1100 for wireless communications, in accordance with certain aspects of the present disclosure. The operations 1100 may be performed, for example, by a UE (e.g., UE 120) and may begin at 1102 by determining a set of resources for an enhanced physical broadcast channel (EPBCH), wherein the set of resources is the same as those for a legacy physical broadcast channel (PBCH).

At 1104, the UE may process an EPBCH from a base station based on the determined set of resources for the EPBCH.

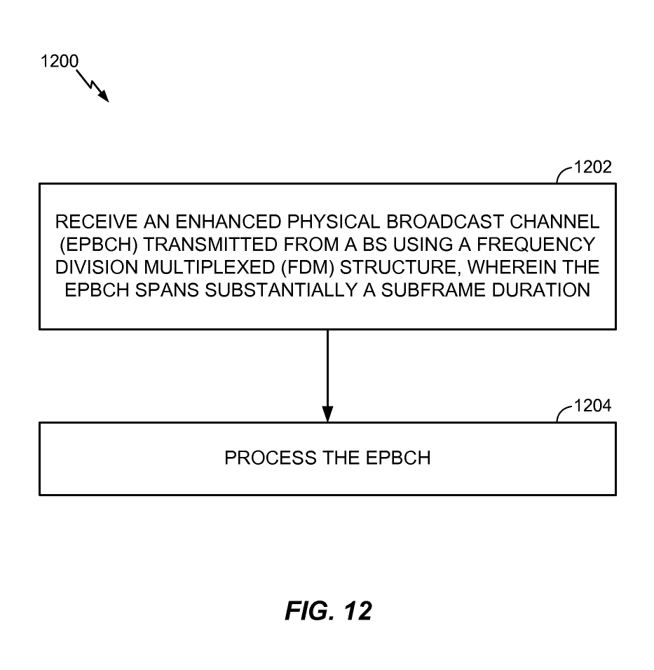

FIG. 12 illustrates example operations 1200 for wireless communications, in accordance with certain aspects of the present disclosure. The operations 1200 may be performed, for example, by a UE (e.g., UE 120) and may begin at 1202 by receiving an enhanced physical broadcast channel (EPBCH) transmitted from a BS using a frequency division multiplexed (FDM) structure, wherein the EPBCH spans substantially a subframe duration.

At 1204, the UE may process the EPBCH.

The various operations of methods described above may be performed by any suitable means capable of performing the corresponding functions. The means may include various hardware and/or software/firmware component(s) and/or module(s), including, but not limited to a circuit, an application specific integrated circuit (ASIC), or processor. Generally, where there are operations illustrated in the Figures, those operations may be performed by any suitable corresponding counterpart means-plus-function components.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or combinations thereof.

Those of skill would further appreciate that the various illustrative logical blocks, modules, circuits, and algorithm steps described in connection with the disclosure herein may be implemented as electronic hardware, software/firmware, or combinations thereof. To clearly illustrate this interchangeability of hardware and software, various illustrative components, blocks, modules, circuits, and steps have been described above generally in terms of their functionality. Whether such functionality is implemented as hardware or software/firmware depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software/firmware module executed by a processor, or in a combination thereof. A software/firmware module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software/firmware, or combinations thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available medium that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

As used herein, a phrase referring to “at least one of” a list of items refers to any combination of those items, including single members. As an example, “at least one of a, b, or c” is intended to cover a, b, c, a-b, a-c, b-c, and a-b-c.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communications by a base station (BS), comprising:
generating an enhanced physical broadcast channel (EPBCH) using a frequency division multiplexed (FDM) structure, wherein the EPBCH spans substantially a subframe duration; and
transmitting the EPBCH.

2. The method of claim 1, wherein if EPBCH is to be transmitted in a same subframe as one or more of a primary synchronization signal (PSS), a secondary synchronization signal (SSS), a common reference signal (CRS), or a demodulation reference signal (DM-RS), REs occupied by the one or more of these signals are excluded from the EPBCH transmission.

3. The method of claim 1, wherein EPBCH resources are assigned based on actual common reference signal (CRS) configurations.

4. The method of claim 1, wherein a number of resource blocks (RBs) spanned by the EPBCH is less than a number of RBs spanned by a legacy PBCH.

5. The method of claim 1, wherein at least one physical resource block (PRB) pair is used for the EPBCH transmission.

6. The method of claim 5, wherein a location of the at least one PRB pair used for EPBCH is within a center 6 PRB pairs.

7. The method of claim 1, wherein at least two physical resource block (PRB) pairs are used for the EPBCH transmission and the at least two PRB pairs for EPBCH are physically non-consecutive.

8. The method of claim 6, wherein, if physical downlink shared channel (PDSCH) is scheduled with PRB pairs that overlap with EPBCH PRB pairs, the overlapped EPBCH PRB pairs are excluded from PDSCH by a user equipment (UE).

9. The method of claim 5, wherein a location of the at least one PRB pair for the EPBCH is cell-independent.

10. The method of claim 5, wherein a location of the at least one PRB pair for the EPBCH is cell-dependent.

11. The method of claim 5, wherein same EPBCH information is transmitted multiple times in an EPBCH transmission time interval (TTI) period.

12. The method of claim 11, wherein the location of the at least one PRB pair for EPBCH is different for different transmissions within an EPBCH TTI period.

13. The method of claim 12, wherein the locations change according to a hopping pattern.

14. The method of claim 12, wherein the hopping pattern is cell-specific.

15. The method of claim 1, wherein a subframe offset for the EPBCH transmission is cell-specific.

16. The method of claim 1, wherein a common reference signal (CRS) scrambling sequence periodicity is used to indicate a starting frame for EPBCH.

17. The method of claim 1, wherein if a channel state information reference signal (CSI-RS) collides with the EPBCH, the CSI-RS is dropped.

18. The method of claim 1, wherein if a channel state information reference signal (CSI-RS) collides with the EPBCH, only a portion of the CSI-RS in EPBCH physical resource block (PRB) pairs is dropped.

19. The method of claim 1, further comprising utilizing a secondary synchronizing signal (SSS) as a reference signal for EPBCH.

20. The method of claim 1, further comprising utilizing one or more resource elements (REs) corresponding to a common reference signal (CRS) to convey a reference signal for EPBCH.

21. The method of claim 1, wherein the EBPCH carries at least one of a location of a common search space, a size of a common search space, a location of an enhanced hybrid acknowledgement channel, and a size of an enhanced hybrid acknowledgement channel.

22. The method of claim 1, wherein the information carried in the EPBCH is different than information carried in a legacy PBCH.

23. A method for wireless communications by a base station (BS), comprising:
determining a set of resources for an enhanced physical broadcast channel (EPBCH), wherein the set of resources is the same as those for a legacy physical broadcast channel (PBCH);
generating at least a portion of the EPBCH in a manner that allows the EPBCH to be distinguished from a legacy PBCH; and
transmitting the EPBCH to at least one user equipment (UE) based on the determined set of resources for the EPBCH.

24. The method of claim 23, wherein a cyclic redundancy check (CRC) value of the EPBCH is scrambled in a manner that is different than a CRC of a legacy PBCH.

25. The method of claim 23, wherein a portion of information carried in the EPBCH is scrambled in a manner that allows the EPBCH to be distinguished from the legacy PBCH.

26. An apparatus for wireless communications by a base station (BS), comprising:
means for generating an enhanced physical broadcast channel (EPBCH) using a frequency division multiplexed (FDM) structure, wherein the EPBCH spans substantially a subframe duration; and
means for transmitting the EPBCH.

27. The apparatus of claim 26, wherein if EPBCH is to be transmitted in a same subframe as one or more of a primary synchronization sequence (PSS), a secondary synchronization sequence (SSS), a common reference signal (CRS), or a demodulation reference signal (DM-RS), REs occupied by the one or more of these signals are excluded from the EPBCH transmission.

28. The apparatus of claim 26, wherein at least one physical resource block (PRB) pair is used for the EPBCH transmission.

29. An apparatus for wireless communications by a base station (BS), comprising:
means for determining a set of resources for an enhanced physical broadcast channel (EPBCH), wherein the set of resources is the same as those for a legacy physical broadcast channel (PBCH);
means for generating at least a portion of the EPBCH in a manner that allows the EPBCH to be distinguished from a legacy PBCH; and
means for transmitting EPBCH to at least one user equipment (UE) based on the determined set of resources for the EPBCH.

30. The apparatus of claim 29, wherein a cyclic redundancy check (CRC) value of the EPBCH is scrambled in a manner that is different than a CRC of a legacy PBCH.
